(19) United States
(12) Patent Application Publication
(10) Pub. No.: US 2003/0049954 A1
(43) Pub. Date: Mar. 13, 2003

(54) PC cartridge having enhanced front connecting structure

(75) Inventors: Anderson Lin, Taipei Hsien (TW); Oswald Ku, Taipei Hsien (TW)

Correspondence Address: BACON & THOMAS, PLLC, 625 SLATERS LANE, FOURTH FLOOR, ALEXANDRIA, VA, 22314

(73) Assignee: D&C Technology Co., Ltd., Taipei Hsien (TW)

(21) Appl. No.: 10/207,035

(22) Filed: Jul. 30, 2002

Related U.S. Application Data
(63) Continuation of application No. 09/948,658, filed on Sep. 10, 2001, now abandoned.

(51) Int. Cl. H01R 12/00

(52) U.S. Cl. 439/76.1

(57) ABSTRACT

A PC cartridge is provided at two front corners of an upper shell with two folded hooks that define a predetermined small height and rearward openings, and at two front ends of two packing rubbers attached to two sides of a bottom shell of the PC cartridge with two retaining slots, each of which includes a forward projected flange portion. When the upper shell is closed onto the bottom shell, the folded hooks extend into the retaining slots to fitly engage with the flange portions and therefore be retained to the retaining slots. The engagement of the folded hooks with the flange portions of the retaining slots produces a vertical coupling stress, enabling the coupled upper and bottom shells of the PC cartridge to resist increased pull applied on them without easily becoming deformed.

### FIELD OF THE INVENTION

The present invention relates to improvements made to a PC cartridge, and more particularly to a PC cartridge having enhanced front connecting structure that enables coupled upper and bottom shells of the PC cartridge to resist higher vertical pull applied on them and thereby protects the PC cartridge from easy deformation and ensures secure and reliable mounting of connection ports on the PC cartridge.

### BACKGROUND OF THE INVENTION

FIG. 1 snows a conventional PC cartridge that is mainly formed from an upper shell A1, a bottom shell A2, packing rubbers A3 provided on two sides of the bottom shell A2, and two connection ports A4 located at front and rear ends of the PC cartridge. Both the upper and the bottom shells A1, A2 are provided at front and rear ends adjacent to the connection ports A4 with locating flanges A5. Each of the locating flanges A5 has a free end inclining toward the connection port A4, and each of the connection ports A4 is provided at upper and lower sides with coupling holes All corresponding to the locating flange A5. When the conventional PC cartridge of FIG. 1 is fully assembled, the locating flanges A5 are set in the coupling holes A11 and therefore do not easily become warped to produce any gap. Since the front and the rear end of the upper and the bottom shell are properly received in the coupling holes, they are not easily subjected to damages and deformation due to external forces. Thus, components received in the conventional PC cartridge are well protected against dust that might otherwise enter the PC cartridge due to gaps between warped upper and bottom shells, and no hardware interference would occur at the time, the conventional PC cartridge is inserted into or extracted from a slot on a computer.

The conventional PC cartridge of FIG. 1 is also provided at the packing rubbers A3 with front hook holes A9 for engaging with front hooks A7 provided at two front corners of the upper shell A1, and at two longitudinal sides of the upper shell A1 with L-shaped coupling flanges A6 for engaging with flanges or grooves provided at the packing rubbers A3. These arrangements allow the upper shell A1 and the bottom shell A2 to securely connect to one another by hooking their front ends together and snapping their rear ends together. No gap is left between the two shells to cause any looseness of the conventional PC cartridge of FIG. 1.

The conventional PC cartridge of FIG. 1 is further provided at two rear corners of the upper shell A1 with rear hooks A8. The rear hooks A8 are so configured that they could be snapped onto the bottom shell A2 after the front hooks A7 have been engaged with the front hook holes A9. To disassemble the PC cartridge of FIG. 1, simply upward pull the upper shell A1 at its front end to remove the upper shell A1 from the bottom shell A2. The conventional PC cartridge of FIG. 1 could therefore be very easily assembled and disassembled.

Tests prove the above-described coupling structure for the conventional PC cartridge of FIG. 1 enables reliable connection of the upper shell to the bottom shell. However, the engagement of the front hooks A7 with the front hook holes A9 does not provide fully sufficient coupling stress.

### SUMMARY OF THE INVENTION

It is therefore a primary object of the present invention to provide an improved PC cartridge having enhanced front connecting structure, so that two coupled upper and bottom shells of the PC cartridge could resist higher vertical pull applied on them to more effectively protect the PC cartridge from easy deformation.

To achieve the above and other objects, the PC cartridge of the present invention is provided at two front corners of an upper shell with two folded hooks that define a predetermined small height and rearward openings, and at two front ends of two packing rubbers attached to two sides of a bottom shell of the PC cartridge with two retaining slots, each of which includes a forward projected flange portion. When the upper shell is closed onto the bottom shell, the folded hooks extend into the retaining slogs to fitly engage with the flange portions and therefore be retained to the retaining slots. Such engagement of the folded hooks with the flange portions of the retaining slots produces a much stronger vertical coupling stress than that could be provided by the front hooks and the front hook holes in the conventional PC cartridge, enabling the coupled upper and bottom shells of the PC cartridge of the present invention to resist increased pull applied on them without easily becoming deformed or separating from each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional PC cartridge;

FIG. 2 is an exploded perspective view of a PC cartridge according to the present invention;

FIG. 3 is a fragmentary and enlarged view of the circled area of FIG. 2 showing the retaining slot provided on a front portion of the packing rubber of the PC cartridge of the present invention;

FIG. 4 is a fragmentary sectioned side view of the PC cartridge of the present invention showing the engagement of the front folded hook of the upper shell with the flange portion of the retaining slot on the packing rubber; and

FIG. 5 is a fragmentary and enlarged view of the circled area of FIG. 4.

### DETAILED DESCRIPTION OF THE PREFERRED EMBODIMENTS

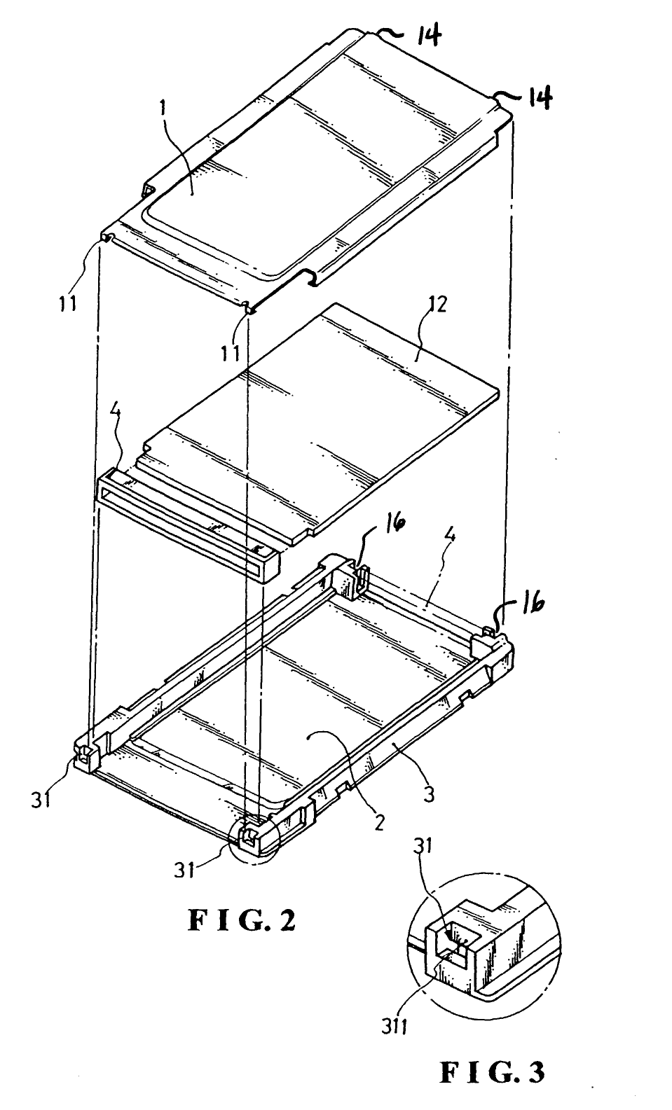

Please refer to FIG. 2 that is an exploded perspective view of a PC cartridge according to the present invention. As shown, the PC cartridge mainly includes an upper shell 1, a bottom shell 2, packing rubbers 3 provided at two sides of the bottom shell 2, and connection ports 4 separately provided at front and rear ends of the PC cartridge. The entire PC cartridge defines therein a rectangular flat space for accommodating a PC board 12 that stores predetermined software and data, and other related devices.

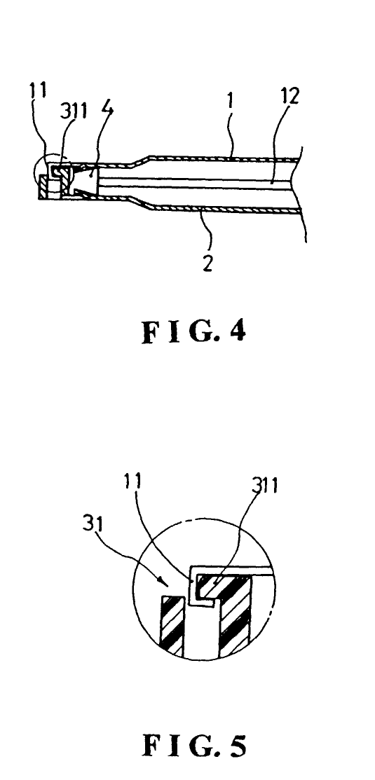

The PC cartridge of the present invention is characterized in that the upper shell 1 is provided at two front corners with two folded hooks 11. That is, each of the folded hooks 11 has a sectional profile in the shape of a lying letter “n”. More specifically, the folded hook 11 defines a small height and has a rearward opening, as can be seen from FIGS. 4 and 5. The PC cartridge of the present invention is also characterized in that the packing rubbers 3 on the bottom shell 2 are provided at front ends with two retaining slots 31 corresponding to the two folded hooks 11 on the upper shell 1.

Please refer to FIGS. 3, 4 and 5. Each of the retaining slots 31 includes a forward projected flange portion 311, such that the folded hook 11 extends into the retaining slot 31 to fitly engage with the flange portion 311 when the upper shell 1 is firmly closed onto the bottom shell 2.

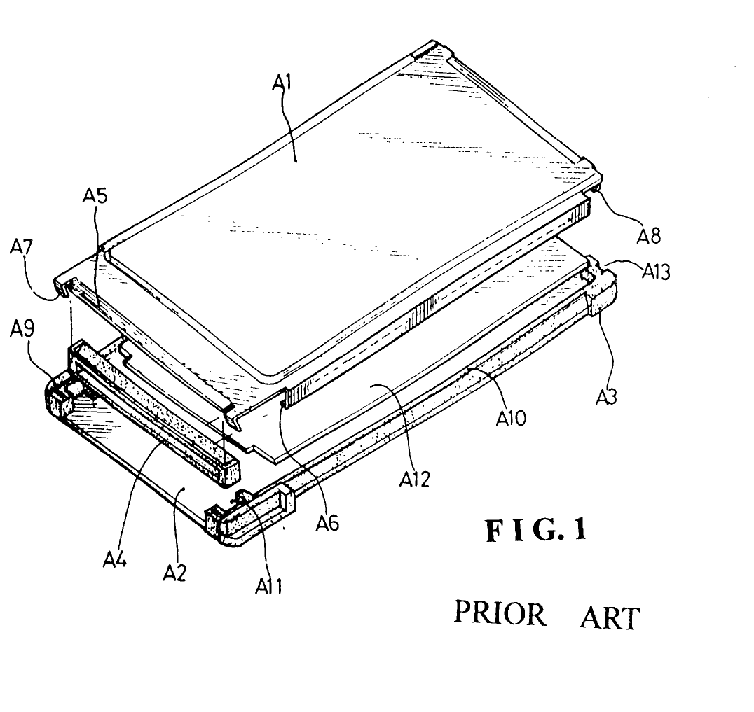

A coupling stress generated from the engagement of the folded hooks 11 with the flange portions 311 of the retaining slots 31 enables the front opening of the PC cartridge and the connection port 4 set in the front opening to be more secure and reliable for use, as shown in FIG. 4. Tests prove that, after the folded hooks 11 on the upper shell 1 are fitly engaged with the flange portions 311 of the retaining slots 31 on the bottom shell 2, both a vertical pull applied on the upper and the bottom shells 1, 2 to separate the two shells and a backward pull applied on the upper shell 1 to pull the same toward the bottom shell 2 are larger than a coupling stress of the connection structure of the conventional PC cartridge of FIG. 1. Moreover, the problem of openings between warped upper and bottom shells 1, 2 may be effectively avoided, and the secure mounting of the connection ports 4 in the PC cartridge can be ensured.

In brief, the PC cartridge of the present invention has enhanced front connecting structure that provides largely increased coupling stress, as compared with the conventional PC cartridge, and is therefore more practical for use.

What is claimed is:

1. A PC cartridge having enhanced front connecting structure, comprising rectangular upper and bottom shells, packing rubbers provided at two sides of said bottom shell, and connection ports located at front and rear ends of said PC cartridge; said upper and said bottom shells together defining a flat space between them for accommodating a PC board having predetermined software and data stored therein and other related electronic elements; said PC cartridge being characterized in that said upper shell is provided at two front corners with two folded hooks, and that said packing rubbers are provided at two front ends with two retaining slots corresponding to said two folded hooks; each of said folded hooks having a profile in the shape of a lying letter “n” so as to define a predetermined small height and a rearward opening, and said folded hooks being adapted to extend into said retaining slots and be retained thereto when said upper shell is closed onto said bottom shell.

2. The PC cartridge as claimed in claim 1, wherein each of said retaining slots includes a forward projected flange portion that has a profile corresponding to that of the folded hook, such that said folded hooks extend into said retaining slots to fitly engage with said flange portions when said upper shell is closed onto said bottom shell.
